(19) United States
(12) Patent Application Publication
(10) Pub. No.: US 2023/0172162 A1
(43) Pub. Date: Jun. 8, 2023

(54) Dog Training System

(71) Applicant: Deniece Johnson, Milford, MA (US)

(72) Inventor: Deniece Johnson, Milford, MA (US)

(21) Appl. No.: 17/542,098

(22) Filed: Dec. 3, 2021

(51) Int. Cl. A01K 15/02; A01K 27/00; A01K 5/01; A01K 5/02

(52) U.S. Cl. CPC A01K 15/021; A01K 27/001; A01K 5/0114; A01K 27/009; A01K 5/02

(57) ABSTRACT

A dog training system is disclosed herein. The dog training system generally comprises a mobile device, a collar, and a treat dispenser. The mobile device has software installed on it that is capable of wirelessly operating the various functions of the collar and the treat dispenser. In many embodiments, the software, which is usually a dog training application installed on the mobile device, is capable of operating the functions of the collar and the treat dispenser automatically when certain pre-set parameters are met. This system may allow for simple, efficient, and effective dog training without much effort on the part of a dog owner or trainer.

### BACKGROUND

### Technical Field

The present disclosure relates generally to a dog training system. More particularly the present disclosure relates to a dog training system that utilizes a mobile device, a collar, and a treat dispenser, and software on the mobile device configured to wirelessly operate the collar and the treat dispenser.

### Description of Related Art

The art of training dogs to carry out specific roles dates back to at least as early as the time of the Roman Empire; however, modern methods of training dogs to be compatible household pets and companions began development in the middle of the 20^{th} century with the advent of suburbia.

Systems that combine the use of a shock collar and wires buried in a yard to prevent the dog from leaving the containment area of the yard are well known in the art. However, these systems suffer from a number of shortcomings to which there are a plethora of potential solutions. One of the problems with these systems is that the containment area needs to be pre-set and is otherwise stationary once it is set up.

Some mobile solutions have been attempted; however, these solutions require the dog owner or trainer to have an excellent understanding of dog training methods, pay constant attention to their dogs, and have excellent timing for corrections. Many owners are incapable or too busy to train their dogs efficiently and effectively with the precise timing required for both positive punishment and positive reinforcement methods. Therefore, there has been a long felt need in the art for a solution that allows owners to seamlessly train their dog to perform a desired behavior, such as training dogs to stay close to their owners on hikes or other similar off leash adventures.

Therefore, what is needed is a dog training system, a method of training a dog, or a dog training tool having the following characteristics and benefits over the prior art.

### SUMMARY

The subject matter of this application may involve, in some cases, interrelated products, alternative solutions to a particular problem, and/or a plurality of different uses of a single system or article.

In one aspect, a dog training system is disclosed. The dog training system generally comprises a mobile device, a collar, and a treat dispenser, wherein the mobile device is operable to wirelessly operate the collar and the treat dispenser.

In another aspect, a method of training a dog is disclosed. The method generally comprises the steps of setting parameters in a dog training application installed on a mobile device; strapping a collar on a dog; dispensing treats from a treat dispenser to the dog when the collar, the treat dispenser, or the mobile device indicate it is time to do so based on the parameters in the dog training application.

In yet another aspect, a treat dispenser is disclosed. The treat dispenser generally comprises a body having an exterior and an interior, wherein, the body comprises a power button, a wireless connection button, a speaker grill, and a cap attached to the exterior of the body covering a treat housing within the interior of the body. The automatic treat dispenser also generally comprises a circuit board within the interior of the body, wherein the circuit board comprises a switch and is connected to a battery, a wireless transceiver, and a speaker.

It should be expressly understood that the various physical elements of the present disclosure summarized and further disclosed herein may be of varying sizes, shapes, or otherwise dimensions and made from a variety of different materials or methods of manufacture without straying from the scope of the present disclosure.

### BRIEF DESCRIPTION OF THE DRAWINGS

FIG. 1 provides a perspective view of an embodiment of the present disclosure.

FIG. 2 provides a partially exploded perspective view of another embodiment of the present disclosure.

FIG. 3 provides a perspective view of yet another embodiment of the present disclosure.

FIG. 4 provides a cross sectional perspective view of an embodiment of the present disclosure.

FIG. 5 provides a cross sectional perspective view of another embodiment of the present disclosure.

FIG. 6 provides a perspective view of an embodiment of the present disclosure.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns an improved dog training system. The present disclosure may also concern or relate to methods of training a dog or a specific dog training tool. The embodiments of the system, method, or tool described herein may allow a dog owner or trainer to seamlessly train a dog to accomplish a specific task or to achieve a desired behavior. In most embodiments, the task or behavior that may be taught to the dog is the task of staying close to or within a desired distance of the owner or trainer; however, other desired behaviors may be taught through use of the information disclosed herein. Many embodiments described herein may allow an owner or trainer to go on walks, hikes, or other similar adventures with their dog without the use of a leash.

In most embodiments, the dog training system generally comprises a mobile device, a collar, and a treat dispenser. In many embodiments, the mobile device is a cellphone having wireless capabilities; however, the mobile device may be any other portable device having wireless capabilities. Further, in many embodiments, the collar is a shock collar having wireless capabilities. In some embodiments, the treat dispenser may be manually operated by the owner or trainer; however, in other embodiments, the treat dispenser may be automatically operated. In some embodiments, wherein the treat dispenser is an automatic treat dispenser, the automatic treat dispenser may have wireless capabilities. In most embodiments the mobile device is operable to wirelessly operate at least one element of the collar or the treat dispenser. In many embodiments, the mobile device is operable to wirelessly operate at least one element of the collar or the treat dispenser by having software installed in the mobile device, wherein the software may be configured to wirelessly operate or interact with the collar and the treat dispenser.

In many embodiments, the software installed on the mobile device may be a dog training application. The dog training application may allow the owner or trainer to adjust and pre-set certain parameters for seamless training. In many embodiments, the mobile device may have wireless capabilities by comprising a wireless transceiver therein. The wireless transceiver may have at least one antenna and at least one receiver, which may, respectively, transmit and receive wireless data in the form of wireless radio waves. In some embodiments, the wireless transceiver may transmit and receive wireless radio waves at a frequency range of about 2.4 GHz to 5 GHz. Similarly, in some embodiments, the collar and the automatic treat dispenser may comprise a wireless transceiver, which may comprise a similar structure and may operate at similar frequency ranges to the wireless transceiver of the mobile device. In many embodiments, the mobile device may establish a wireless connection with at least one of the collar or the automatic treat dispenser through wireless radio waves. In one embodiment, the effective range of the wireless connection established between at least one of the collar or the automatic treat dispenser and the mobile device may be approximately 30 feet.

In most embodiments, the collar may comprise a strap, wherein the strap may be used to secure the collar around a dog's neck. In many embodiments, the strap of the collar is adjustable to ensure proper fitting on dogs with varying neck sizes. In most embodiments, the collar also comprises a training element housing attached to the strap of the collar. In most embodiments, the training element housing comprises a body having an exterior and an interior. The training element housing may also comprise various elements that are configured to wirelessly interact with the mobile device and that correspond to the varying functions of the training element housing or collar. For example, in some embodiments, the exterior of the body of the training element housing may comprise a wireless connection button, an ultrasonic transducer, or a speaker grill. Some embodiments of the training element housing may comprise all three elements at once, and other embodiments may comprise only one or two of the three. The wireless connection button may correspond to the wireless function of the training element housing or collar, the ultrasonic transducer may allow the training element housing to create sounds at higher frequencies than the average human ear can perceive, and the speaker grill may allow the training element housing to better propagate sound waves. In some embodiments, the ultrasonic transducer may allow the training element housing to produce sound waves having frequencies above 20 kHz.

In most embodiments, the training element housing may comprise a circuit board, wherein the circuit board may be housed within the interior of the body of the training element housing. In many embodiments, the circuit board may be a printed circuit board (PCB). The circuit board may have various elements or components attached or electrically connected to it that correspond to or operate the functions of the training element housing or collar. For example, in some embodiments, the circuit board may be connected to at least one of the following: a wireless transceiver; a vibration motor; an ultrasonic transducer; a speaker; a microphone; a sensor; or two stimulating prongs. In most embodiments, the circuit board is powered by a battery. In some embodiments, the collar may further comprise a capacitive generator that converts the motion of the dog to an electrical current that charges and extends the life of the battery. The wireless transceiver and the ultrasonic transducer correspond to the functions of establishing a wireless connection and creating ultrasonic sound waves, respectively. In many embodiments, the speaker may convert electrical audio signals into sound waves. In most embodiments, these sound waves propagate through the speaker grill of the training element housing. In some embodiments, a vibration motor may be connected to the circuit board, and the vibration motor may cause the training element housing to vibrate when the vibration motor is in operation. In some embodiments, a microphone may be connected to the circuit board, and the microphone may convert the sound waves generated by a dog's bark or other noises near the training element housing into electrical impulses. In some embodiments, a sensor may be connected to the circuit board, and the sensor may determine the distance between the collar and the mobile device or the collar and the treat dispenser, alternatively or simultaneously.

In most embodiments, the body of the training element housing may have a front face and a rear face, wherein the rear face of the body comprises two stimulating prongs extending away from the body. The stimulating prongs may contact the dog's neck when the collar is strapped to the dog. The stimulating prongs may deliver an electric shock or a static correction to the dog when necessary. The stimulating prongs may be electrically connected to the circuit board within the interior of the body of the training element housing. The strength of the electric shock delivered by the stimulating prongs may be adjustable by the software installed on the mobile device.

A dog training tool or a treat dispenser is disclosed herein. In some embodiments, the treat dispenser may be utilized as part of the dog training system disclosed. In other embodiments, the treat dispenser may not be used as part of the dog training system disclosed. The treat dispenser may be manually operated, wherein the manually operated treat dispenser may be referred to as a manual treat dispenser. In other embodiments, the treat dispenser may operate automatically, wherein the automatically operated treat dispenser may be referred to as an automatic treat dispenser. In yet other embodiments, the automatic treat dispenser may be operated both manually and automatically. Depending on the embodiment, both the manual treat dispenser or the automatic treat dispenser may be a pellet dispenser, a fluid dispenser, or both. The pellet dispenser may dispense solid treats, such as a plurality of pellets, and the fluid dispenser may dispense a fluid treat. The fluid treat may be a high viscosity fluid treat that flows very slowly. For example, in some embodiments, the fluid treat may comprise peanut butter or other similar types of dog-friendly fluid treats.

Both the manual treat dispenser and the automatic treat dispenser may generally comprise a body, a treat housing, a cap, and an aperture. In many embodiments, the treat housing is connected to the body, and the cap may be removably connected to the treat housing in order to contain the treats housed therein. When the cap is connected to the treat housing, the cap may be said to cover the treat housing. In most embodiments, the body of either the manual treat dispenser or automatic treat dispenser may define an aperture, wherein the aperture may allow for the dispensing of treats from the treat housing. Some embodiments of the manual and the automatic treat dispensers may also comprise a strap attached to the body of the treat dispenser. In these embodiments, the treat dispenser may be handheld, and the strap, which may be an adjustable strap, may be wrapped around the wrist of the user. Other embodiments of the manual and the automatic treat dispensers may be worn by the user and, consequently, may comprise a different securing structure including, but not limited to, a clip that may be secured or fixed to the clothing of the user. For example, in some embodiments, the treat dispenser has a strap that can be wrapped and secured around a user's leg, preferably around the user's lower leg close to the user's ankle or foot so that the aperture for dispensing a treat is positioned close to the ground, which may have the benefit of keeping the dog at heel (i.e., close to the user) when the treat dispenser is dispensing a treat.

The manual treat dispenser and the automatic treat dispenser may also comprise a power button, a wireless connection button, an ultrasonic transducer, or a speaker grill connected to the body of either treat dispenser. Similar to the training element housing, the aforementioned elements may correspond to the varying functions of either treat dispenser. For example, the power button may turn either treat dispenser on or off, the wireless connection button may operate the wireless connection functions of either dispenser, the ultrasonic transducer may cause a speaker within the body of either dispenser to emit sound waves at ultrasonic frequencies, and the speaker grill may better allow for the emission and propagation of sound waves from the speaker. Consequently, in many embodiments, the manual treat dispenser and the automatic treat dispenser comprise a circuit board, which may be a PCB, within the body of either treat dispenser, wherein the circuit board may be attached and electrically connected to various elements that correspond to the various functions of either treat dispenser. The circuit board may be connected to a battery, which supplies power to the circuit board and the various elements connected thereon. In some embodiments, the treat dispenser may further comprises a capacitive generator that converts the motion of the owner or trainer into an electrical current that charges and extends the life of the battery. In many embodiments, the circuit board within the body of either treat dispenser may comprise a switch, a wireless transceiver, an ultrasonic transducer, a speaker, and a sensor. The switch, the wireless transceiver, the ultrasonic transducer, the speaker, and the sensor may be attached and electrically connected to the circuit board and may operate the varying functions of either treat dispenser. For example, similar to that of the mobile device and the training element housing, the wireless transceiver may operate the wireless connection function of either treat dispenser, and the switch may turn the circuit board and its various elements on or off. In some embodiments, the treat dispenser may also comprise a sensor, which may determine the distance between the treat dispenser and the collar may cause the speaker to emit a sound or cause a solid or fluid treat to be dispensed, alternatively or simultaneously, depending on the embodiment. The solid or fluid treat may be dispensed from the treat dispenser through similar mechanisms to those explicitly disclosed herein in the various embodiments.

In the automatic treat dispenser embodiments, the circuit board may be connected to a motor. The motor may be an electric motor that converts electrical energy into rotational motion. In many of the automatic treat dispenser embodiments, the motor may be connected to a first end of a cam and gear mechanism. In the pellet dispenser embodiment of the automatic treat dispenser, the cam and gear mechanism may be connected to a barrier at a second end of the cam and gear mechanism. In the fluid dispenser embodiment of the automatic treat dispenser, the cam and gear mechanism may be connected to a trigger mechanism or a pump at a second end of the cam and gear mechanism, depending on the embodiment. The cam and gear mechanism may comprise a series of cams, gears, or other similar components that may be necessary to transform the rotational motion generated by the motor into the desired motion of the pump or barrier.

In the pellet dispenser embodiment of the automatic treat dispenser, the treat housing may comprise a funnel tube within the body of the dispenser that may be filled with pellets. In many embodiments, the funnel tube may be connected to a first end of an exit tube, wherein the exit tube is connected at a second end to the aperture of the pellet dispenser. The pellets may be prevented from falling through the exit tube and the aperture by a barrier, which may be connected to the second end of a cam and gear mechanism. In most embodiments, cross sectional portions of the funnel tube and the exit tube may connect at a first end of the exit tube. The location where the funnel tube and the exit tube connect may be referred to as the connection between the funnel tube and the exit tube. The connection between the funnel tube and the exit tube may define an aperture, wherein the barrier may extend through the aperture. In this way, the barrier may prevent pellets from falling from the funnel tube into the exit tube and out the aperture of the pellet dispenser inadvertently. The barrier may be caused to reciprocally or linearly move up and down or in and out of the aperture of the connection between the funnel tube and the exit tube when the motor is operational due to the cam and gear mechanism being connected to both the motor and the barrier. In many embodiments, this is the way pellets may be released from the treat housing through the aperture of the pellet dispenser.

In the fluid dispenser embodiment of the automatic treat dispenser, the treat housing may be a tube within the body of the fluid dispenser, and the treat housing may be filled with a fluid, which may be a fluid treat, such as peanut butter or another similar dog-friendly treat. In some embodiments, the treat housing may be connected to a pump connector, wherein the pump connecter may be attached to a pump, and the pump may be attached to a pump exit tube. In some embodiments, the pump exit tube may be connected to the aperture of the body of the fluid dispenser. In other embodiments, the pump exit tube may define its own aperture that may allow the fluid to flow through and out the aperture of the body of the fluid dispenser. In many embodiments, a vacuum may prevent fluid from flowing through the pump, into the pump exit tube, and, consequently, out the aperture which may be defined in either the pump exit tube, the body of the fluid dispenser, or both, depending on the embodiment. In the embodiments where a vacuum prevents fluid from flowing out either the aperture of the pump exit tube, the aperture of the body of the fluid dispenser, or both, fluid may be released and allowed to flow through either aperture when external pressure is applied to the pump. In some embodiments, the cam and gear mechanism may be connected directly to the pump. In other embodiments, the cam and gear mechanism may be connected to a trigger mechanism which may contact or rest on the exterior of the pump, the exterior of the pump connector, or the exterior of the pump exit tube, alternatively or simultaneously. In both embodiments, external pressure or force may be applied to the pump when the motor is operational due to the cam and gear mechanism being connected to either the pump or the trigger mechanism and the motor. In many embodiments, this is the way in which fluid may be released from the treat housing within the body of the fluid dispenser.

In some embodiments, the manual treat dispenser may also be a pellet dispenser or a fluid dispenser. Moreover, in some embodiments, the manual treat dispenser may comprise a cam and gear mechanism. However, unlike the automatic treat dispenser embodiments, the manual treat dispenser may not utilize a motor connected to the cam and gear mechanism to operate the mechanism. Rather, in many manual treat dispenser embodiments, the cam and gear mechanism may be operated by a switch, lever, button, or other similar structure on the exterior of the body of the treat dispenser. Some embodiments of the manual treat dispenser may not comprise a cam and gear mechanism within the body of the manual treat dispenser. In these embodiments of the manual treat dispenser, the manual treat dispenser may dispense either pellet or fluid treats through another mechanism. For example, in some embodiments where the manual treat dispenser is a pellet dispenser, the barrier on the interior of the body of the pellet dispenser may be connected directly to a lever on the exterior of the body of the pellet dispenser. In the lever embodiment, the lever may be reciprocally moved back and forth to reciprocally move the barrier in and out of the aperture defined in the connection between the funnel tube and the exit tube. As another example, in some embodiments where the manual treat dispenser is a fluid dispenser, the treat housing may comprise a rod connected to a disc within the treat housing and the body of the fluid dispenser may comprise an incrementally rotatable switch that causes the rod to push the disc, which may cause the fluid to be pushed out of the manual fluid dispenser. In some embodiments, the treat dispenser may be both manually operated and automatically operated. In the embodiments where the treat dispenser is both a manual and an automatic treat dispenser, the treat dispenser may comprise any combination of elements disclosed in the various embodiments of the present disclosure.

A method of training a dog through use of the dog training system of the present disclosure is also disclosed herein. In most embodiments, the first step of the method comprises setting parameters on a software, such as the dog training application. The software or dog training application may be installed on a stationary device, such as a desktop, a mobile device, such as a laptop, tablet, or cellphone, or both, depending on the embodiment. In most embodiments, subsequent steps of the method may comprise fixing the collar to the dog, typically by strapping and adjusting the strap around the dog's neck, and fixing the treat dispenser to the owner or trainer by wrapping and adjusting the strap around the owner's or trainer's wrist or by clipping or otherwise fixing the treat dispenser to clothing worn by the owner or trainer, depending on the embodiment. The method may comprise any additional steps necessary to effectively operate the system, and the steps may be conducted in any order.

The parameters set may correspond to the desired behavior to be taught and, consequently, the desired behavior to be taught may correspond to the pre-set parameters. For example, in most embodiments, the desired behavior to be taught may be the dog staying within a proximity circle, wherein the dog trainer or owner is the center of the proximity circle. In most embodiments, the dog trainer or owner may be the center of the proximity circle by holding a mobile device or another device configured to wireless interact with the collar and the treat dispenser in order to determine the distance between the dog and the owner. The distance between the dog and the owner may be the parameter used to determine when to provide positive punishment or positive reinforcement to the dog via the collar or the treat dispenser. For example, in some embodiments, the parameters for the proximity circle may be to provide positive reinforcement to the dog when the dog is within two (2) feet of the owner and to start providing positive punishment when the dog begins to exceed a distance of five (5) feet from the owner.

In most embodiments of the method, the parameters for positive reinforcement and positive punishment, such as the timing of the stimulus and the amount of the stimulus, may be adjustable and will vary depending on numerous factors including, but not limited to, the dog, the owner or trainer, and the desired behavior. For example, in some embodiments, the desired behavior may be preventing the dog from barking. In such embodiments, the parameters set for positive punishment may be, for example, to start providing positive punishment when the dog barks three (3) times in a row and to provide increasing levels of positive punishment as the dog exceeds three (3) barks. Similarly, in such embodiments, the parameters set for positive reinforcement may be to provide positive reinforcement within three (3) seconds of when the dog stops barking.

In many embodiments, the collar may provide positive punishment. The positive punishment may correspond to the functions of the collar. For example, the positive punishment may include, but is not limited to, an unpleasant beeping sound emitted from the speaker of the training element housing, an unpleasant vibration produced by the vibration motor within the training element housing, or a static correction or electric shock emitted from the stimulating prongs of the training element housing. The amount and timing of positive punishment provided may vary and be adjustable via the dog training application. Similarly, in many embodiments, the treat dispenser may provide positive reinforcement. The positive reinforcement may correspond to the functions of the treat dispenser. For example, the positive reinforcement may include, but is not limited to, a pleasant ultrasonic sound emitted from the speaker of the treat dispenser or solid or fluid treats dispensed from the aperture of the treat dispenser. The amount and the timing of positive reinforcement provided may vary and be adjustable via the dog training application. It should also be noted that in some embodiments, the collar may provide positive reinforcement and the treat dispenser may provide positive punishment. For example, in some embodiments, the collar may emit a pleasant sound from the speaker of the training element housing, and the treat dispenser may emit an unpleasant sound from the speaker of the dispenser. Some embodiments of the method also utilize negative reinforcement and negative punishment.

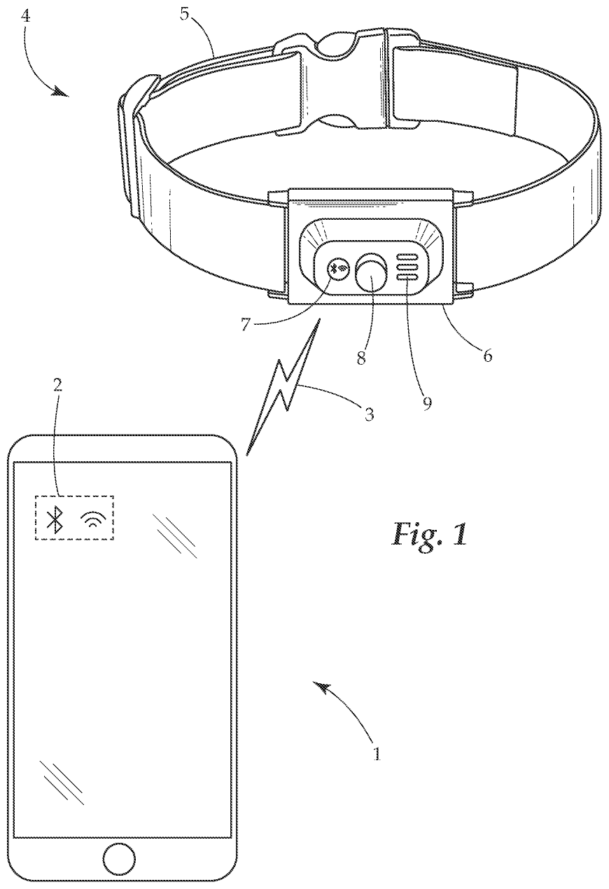

Turning now to FIG. 1, which shows an embodiment of the system utilizing a cell phone 1 having a wireless transceiver 2 therein. A wireless connection is established between the cell phone 1 and the collar 4 through wireless radio waves 3. The collar 4 has a strap 5 connected to the body of the training element housing 6. In this embodiment, the exterior of the body of the training element housing 6 has a wireless connection button 7, an ultrasonic transducer 8, and a speaker grill 9.

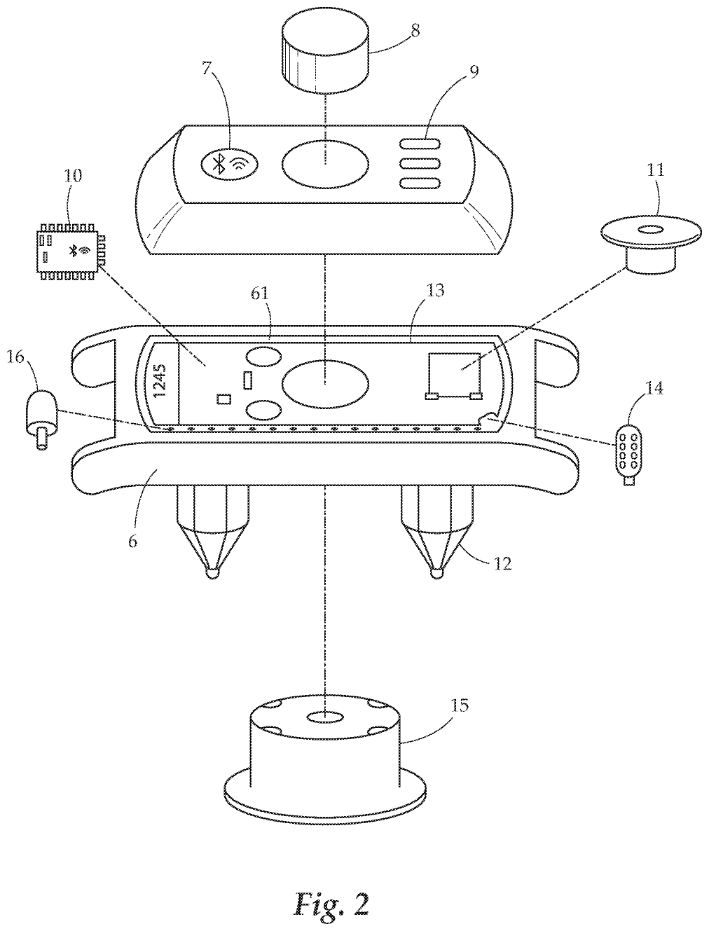

FIG. 2 shows a partially exploded perspective view of an embodiment of the body of the training element housing 6. This perspective view reveals the circuit board 13 housed within the interior 61 of the body of the training element housing 6 and various components that are connected within the interior 61 of the body of the training element housing 6. In this embodiment, the circuit board 13 will be connected to a wireless transceiver 10; a vibration motor 16; an ultrasonic transducer 8; a speaker 11; a microphone 14; two stimulating prongs 12; and a battery 15. The wireless connection button 7 operates the wireless transceiver 2 and the sound emitted from the speakers passes through the speaker grill 9.

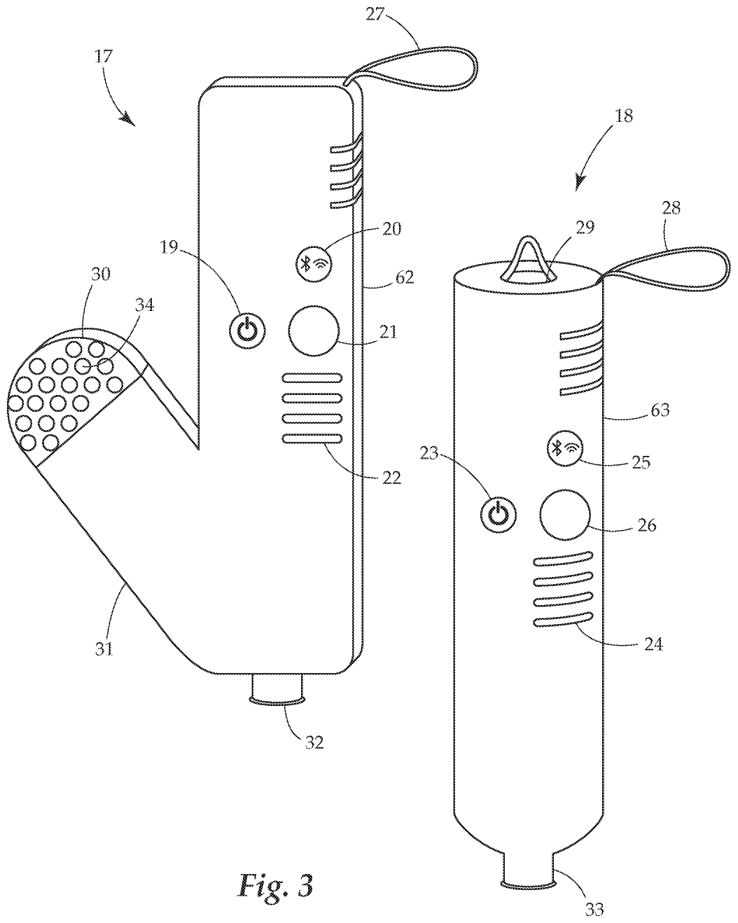

FIG. 3 shows two different embodiments of an automatic treat dispenser. One of the automatic dispenser embodiments is a pellet dispenser 17 and the other is a fluid dispenser 18. The pellet dispenser 17 has a power button 19; a wireless connection button 20; and ultrasonic transducer 21; and a speaker grill 22 connected to the body 62 of the pellet dispenser 17. The body 62 of the pellet dispenser 17 also comprises or defines an aperture 32 and a treat housing 31 for the dispensing of pellets 34. The treat housing 31 is also connected to a transparent cap 30, which reveals the pellets 34 contained within the treat housing 31. The pellet dispenser 17 also comprises a strap 27. The fluid dispenser 18, similar to the pellet dispenser 17, comprises a power button 23; a wireless connection button 25; an ultrasonic transducer 26; a speaker grill 24; and a strap 28 connected to the body 63 of the fluid dispenser 18. The body 63 of the fluid dispenser 18 also comprises or defines an aperture 33 for the dispensing of a fluid treat (not shown). A twistable cap 29 is screwed into the body 63 and is removed in order to fill the fluid dispenser 18 with a fluid treat (not shown).

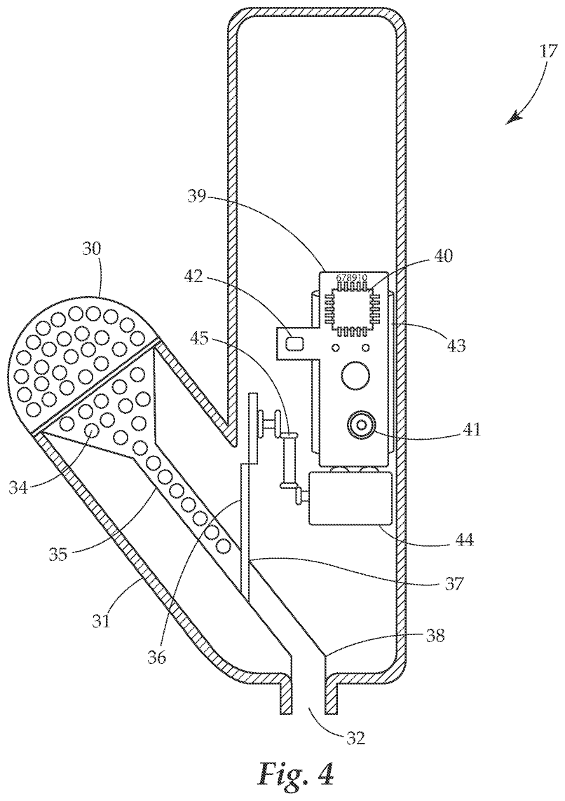

FIG. 4 shows a cross sectional view of the pellet dispenser 17. The transparent cap 30 is connected to a funnel tube 35 within the treat housing 31, wherein the funnel tube 35 is filled with pellets 34. The funnel tube 35 is connected to an exit tube 38. The pellets 34 in the funnel tube 35 are prevented from falling through the exit tube 38 and, consequently, the aperture 32, connected to an end of the exit tube 38, by a barrier 36. The barrier 36 extends through an aperture 37 defined at a portion of the connection between the funnel tube 35 and the exit tube 38. The barrier 36 is connected to a cam and gear mechanism 45, which is connected to an electric motor 44 and transforms the rotational motion generated by the motor 44 into linear motion that moves the barrier 36 up and down when the motor 44 is in operation. The motor 44 is electrically connected to a circuit board 39. The circuit board 39 comprises a switch 42; a wireless transceiver 40; and a speaker 41. The circuit board 39 and, consequently, the various components electrically connected thereto, is powered by a battery 43.

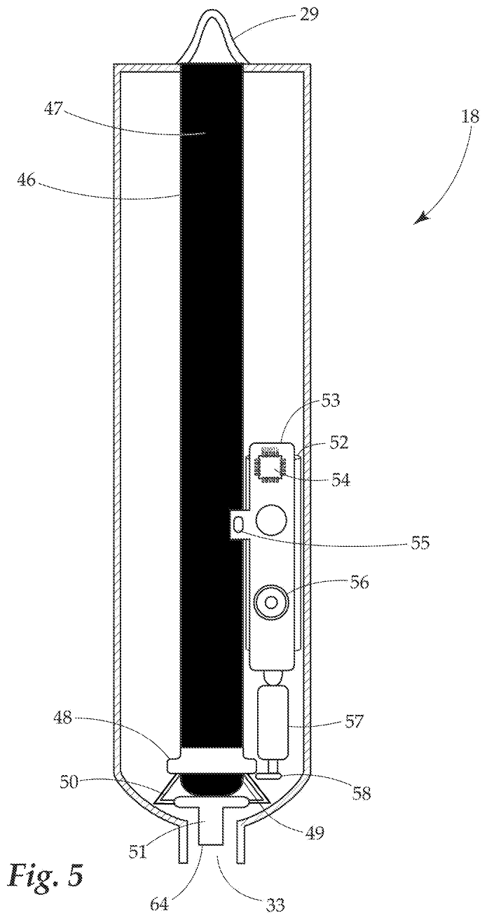

FIG. 5 shows a cross sectional view of the fluid dispenser 18. The twistable cap 29 is connected to the dispenser 18 and covers the top of a treat housing 46, which is filled with a fluid 47. The treat housing 46 is connected to a pump connector 48. The pump connector 48 is attached to a pump 49, and the pump 49 is attached to a pump exit tube 51 having an aperture 64. Fluid 47 flows through the treat housing 46 and the pump connector 48 and into the pump 49. A vacuum prevents the fluid 47 from flowing through the aperture 64 at the end of the pump exit tube 51. Fluid 47 is released through the aperture 64 in the pump exit tube 51 and allowed to flow out of the aperture 33 in the fluid dispenser 18 when a trigger mechanism 50 applies external pressure to the pump 49. The trigger mechanism 50 is connected to a cam and gear mechanism 58, which is connected to an electric motor 57 and transforms the rotational motion generated by the motor 57 into a squeezing or reciprocating motion that causes the trigger mechanism 50 to apply external pressure to the pump 49 when the motor 57 is in operation. The motor 57 is electrically connected to a circuit board 53. The circuit board 53 comprises a switch 55; a wireless transceiver 54; and a speaker 56. The circuit board 53 and, consequently, the various components electrically connected thereto, is powered by at least one battery 52.

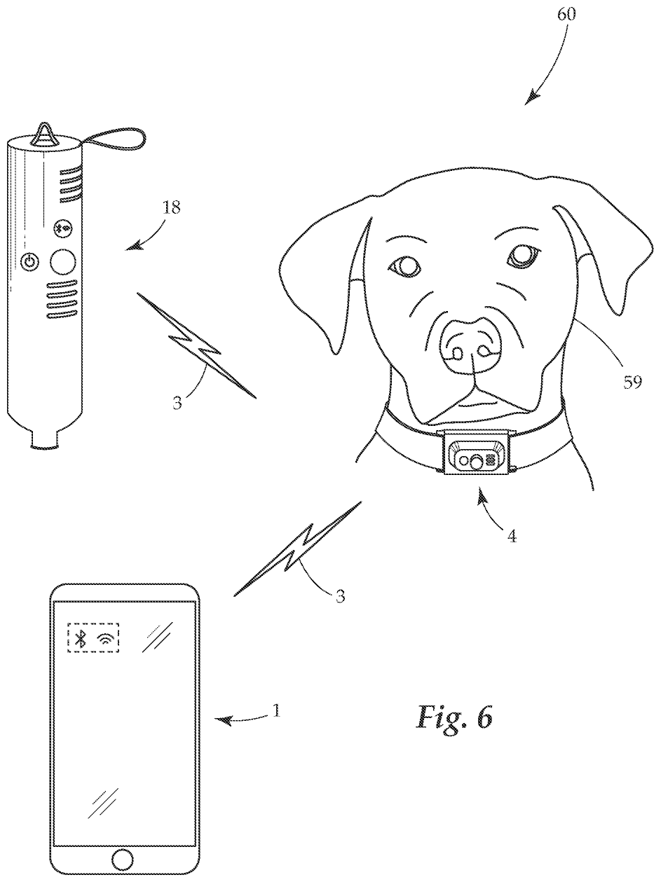

FIG. 6 shows one embodiment of the dog training system 60 that utilizes the cell phone 1, the collar 4 strapped to a dog 59, and, in this embodiment, the automatic fluid dispenser 18. The cell phone 1 has dog training software installed thereon which is configured to wirelessly interact with the collar 4 and the fluid dispenser 18. Both the fluid dispenser 18 and the collar 4 are wirelessly connected to the cell phone 1 through wireless radio waves 3. The software installed on the cell phone 1 sends signals via wireless radio waves 3 to both the dispenser 18 and the collar 4 to operate various functions on both devices at appropriate times in accordance with the system disclosed herein.

While several variations of the present disclosure have been illustrated by way of example in preferred or particular embodiments, it is apparent that further embodiments could be developed within the spirit and scope of the present disclosure, or the inventive concept thereof. However, it is to be expressly understood that elements described in one embodiment may be incorporated with any other embodiment in combination with any other elements disclosed herein in the various embodiments. It is also to be expressly understood that any modifications and adaptations to the present disclosure are within the spirit and scope of the present disclosure, and are inclusive, but not limited to the following appended claims as set forth.

What is claimed is:

1. A dog training system comprising:
a mobile device;
a collar; and
a treat dispenser;
wherein the mobile device is operable to wirelessly operate the collar and the treat dispenser.

2. The dog training system of claim 1 wherein the mobile device further comprises a software and a wireless transceiver, wherein the software and the wireless transceiver cause the mobile device to be operable to wirelessly operate the collar and the treat dispenser.

3. The dog training system of claim 1 wherein the collar comprises a training element housing, wherein the training element housing comprises a body having an exterior and an interior.

4. The dog training system of claim 3 wherein the exterior of the body of the training element housing comprises a wireless connection button, a speaker grill, and two stimulating prongs.

5. The dog training system of claim 3 wherein the interior of the body of the training element housing comprises a circuit board, a battery, a wireless transceiver, and a speaker, wherein the circuit board is connected to the battery, the wireless transceiver, and the speaker.

6. The dog training system of claim 1 wherein the treat dispenser is a manual treat dispenser.

7. The dog training system of claim 1 wherein the treat dispenser is an automatic treat dispenser.

8. The dog training system of claim 7 wherein the automatic treat dispenser comprises a power button; a wireless connection button; a speaker grill; a cap attached to the automatic treat dispenser and covering a treat housing;
and an aperture for dispensing a treat.

9. The dog training system of claim 7 wherein the automatic treat dispenser comprises a circuit board within the automatic treat dispenser, wherein the circuit board comprises a switch and is connected to a battery; a wireless transceiver; a speaker; and a motor.

10. The dog training system of claim 9 wherein the automatic treat dispenser further comprises an ultrasonic transducer connected to the circuit board.

11. The dog training system of claim 8 wherein the automatic treat dispenser is a pellet dispenser comprising a plurality of pellets within the treat housing.

12. The dog training system of claim 11 wherein the pellet dispenser comprises a funnel tube within the treat housing, and the funnel tube is connected to the cap and forms a connection with an exit tube.

13. The dog training system of claim 12 wherein the connection between the funnel tube and the exit tube defines an aperture, wherein a barrier extends through the aperture and separates the funnel tube from the exit tube.

14. The dog training system of claim 13 wherein the barrier is connected to a cam and gear mechanism, wherein the cam and gear mechanism is connected to a motor.

15. The dog training system of claim 8 wherein the automatic treat dispenser is a fluid dispenser comprising a body, wherein the treat housing is within the body and a fluid is within the treat housing.

16. The dog training system of claim 15 wherein the treat housing is connected to a pump connector, the pump connector is connected to a pump, and the pump is attached to a pump exit tube defining an aperture.

17. The dog training system of claim 16 wherein the fluid within the treat housing flows through the pump connector and into the pump, wherein a vacuum prevents the fluid from flowing through the pump exit tube and out the aperture of the pump exit tube.

18. The dog training system of claim 17 wherein the fluid dispenser comprises a trigger mechanism within the body of the fluid dispenser, wherein the trigger mechanism rests on an exterior of at least one of the pump connector, the pump, or the pump exit tube.

19. The dog training system of claim 18 wherein the trigger mechanism is connected to a cam and gear mechanism, wherein the cam and gear mechanism is connected to a motor.

20. A method of training a dog comprising the steps of:
setting parameters on a mobile device;
providing a collar;
providing a treat dispenser; and
dispensing treats from the treat dispenser based on the parameters set on the mobile device.
